(19) United States
(12) Patent Application Publication
(10) Pub. No.: US 2024/0246669 A1
(43) Pub. Date: Jul. 25, 2024

(54) VERTICAL TAKE-OFF AIRCRAFT WITH CANARDS AND PRIMARY WINGS

(71) Applicant: Greensky S.R.L., Genova (IT)

(72) Inventor: Paolo BECCHI, Pietra Ligure (IT)

(73) Assignee: Greensky S.R.L., Genova (IT)

(21) Appl. No.: 18/290,357

(22) PCT Filed: Oct. 19, 2021
(86) PCT No.: PCT/IB2021/059594

§ 371 Date: Nov. 13, 2023

(30) Foreign Application Priority Data
May 11, 2021 (IT) 102021000012014

(51) Int. Cl. B64C 29/00; B64C 39/12

(52) U.S. Cl. CPC B64C 29/0033; B64C 39/12

(57) ABSTRACT

Vertical take-off aircraft provided with canards (1) and primary wings (2), which primary wings (2) are provided with two or more primary thrusters (20). The primary wings (2) are rotatable alternately in a vertical configuration for vertical flight mode and in a horizontal configuration for horizontal flight mode. The canards (1) in said vertical flight mode are arranged substantially parallel to a plane perpendicular to the flight direction, each canard (1) being provided with a secondary thruster (10) oriented for vertical flight mode and at least partially comprised in the profile of the canard (1) itself.

The present invention relates to a vertical take-off aircraft provided with canards and primary wings.

The primary wings are provided with two or more primary thrusters and are alternately rotatable in a vertical configuration for vertical flight mode and in a horizontal configuration for horizontal flight mode.

The aircraft belongs to the category of tiltrotors (VTOL=Vertical Take-Off and Landing), i.e., aircraft which take off as helicopters and fly horizontally as fixed-wing aeroplanes.

The invention is applicable to any type of vertical take-off aircraft and is particularly advantageously applied in vertical take-off aircraft with electric propulsion (eVTOL). This specific technical field will be referred to directly, but not in a limited way, in the following description.

In recent years, many vertical take-off aircraft have been studied and developed to allow for the advancement of mobility in large metropolises and in areas without airports and other communication means.

There is also considerable worldwide demand for electric transport, however the current limitations of rechargeable batteries in terms of energy density, charge/discharge speed and cycle duration problems make the application of this technology to air transport particularly challenging.

This is greatly felt in eVTOL because of the high power required for stationary flight, especially if efficient high-speed cruising and greater autonomy is also required.

Typically in tiltrotors, the same propellers are used for both take-off and vertical flight and for cruise flight, by means of propeller axis tilting means. Depending on the type of such tilting means, tiltroters are divided into four categories: a first category includes the rotation of the entire aircraft and is therefore identified with the term “tailsitter”; a second category includes the rotation of the powertrain only; a third category includes the rotation of the aerodynamic surface to which the powertrain is connected; a fourth category is related to aircraft in which the propellers necessary for vertical flight do not rotate and are different with respect to those used for horizontal flight; in the latter case, the propellers for vertical flight are stopped during horizontal flight.

Document WO2017/200610A1 describes an aircraft falling within the third category mentioned above, in particular a self-piloted, electric and vertical take-off and landing aircraft (eVTOL) which aims to have low noise and reduced cost to operate for freight and passenger transport applications over relatively long distances. The canard and the primary wing are tiltable to bring the thrusters upright for take-off and landing or stationary flight. Such an aircraft has a multi-propeller configuration mounted on each wing to provide redundancy to achieve sufficient propulsion and control in the event of failure of any of the propellers or other flight control devices. The aircraft is electrically powered and can provide sufficient thrust with a relatively low blade speed, which helps reduce noise. However, this type of aircraft has efficiency problems in the transition from the vertical to the horizontal condition of the wings. In fact, in this transition the wings act as air brakes.

Many other eVTOL models have been designed during the testing phase, however there is currently a need not satisfied by the state of the art of a VTOL which ensures low weight and constructive simplicity and at the same time efficient flight performance which allow to optimize autonomy.

The present invention aims to fill this gap and overcome the disadvantages of the state of the art with a VTOL aircraft as described at the beginning, furthermore in which the canards in said vertical flight mode are arranged substantially parallel to a plane perpendicular to the flight direction, each canard being provided with a secondary thruster oriented for vertical flight mode and at least partially comprised in the profile of the canard itself.

The canards are therefore fixed or, preferably, tiltable only at angles of incidence such that the aircraft can perform manoeuvres during horizontal flight.

This allows to obtain in horizontal flight a thrust only from the primary thrusters, placed on the rear wings, and to therefore have more aerodynamic canards, to the great advantage of the overall flight efficiency.

In an embodiment, the canards are provided with housing end recesses rotating the secondary thrusters.

The secondary thrusters are thereby included at the ends of the canards and partly within their profile thanks to said recesses obtained on the head side of the canards themselves. This allows the surface of the canards to be left substantially continuous, allowing them to have a minimal impact on their aerodynamic resistance.

In a further exemplary embodiment, each said secondary thruster comprises two blades, which blades in horizontal flight mode are stationary and arranged substantially parallel to the longitudinal axis of the aircraft to complete the terminal profile of the canard.

In this manner, in horizontal flight mode the thruster is positioned to complete the end chord of the canard within the recess. This allows the secondary thrusters to substantially cancel their resistance to air in the inactive condition and, on the contrary, to contribute to the lift functions of the canards in which they are housed.

According to an embodiment, each canard is provided with a terminal semicircular recess closing element, which closing element is positionable in the recess in horizontal flight mode.

Such a closing element makes it possible to fill the vacuum of the terminal recess of the canards when the thruster is positioned in an inactive condition during horizontal flight. Thereby the canard is substantially free of any significant discontinuity.

According to a further embodiment, the closing element is hinged to the canard and has a first portion shaped at the end of the canard and a second portion shaped in a manner complementary to said semicircular recess, which portions are separated by a through slot for housing the secondary thruster.

Thereby, the closing element is movable from a closing condition in which it is positioned in the recess and completes the profile thereof to an open condition in which it is rotated away from the recess.

In the closing condition, the second portion is positioned in the recess while the first portion is positioned so as to continue the canard and form the head end thereof, and the thruster positioned along the longitudinal axis is housed in the slot included between the two portions, being hidden in the wing and in the shadow with respect to the relative motion of the air.

Advantageously, the open condition includes a positioning of the closing element along the vertical direction or in any case along the vertical flight direction. Thereby, the closing element does not exert any significant resistance to vertical motion. The rotation of the secondary thruster is ensured by the presence of the slot between the two portions of the closing element.

In an embodiment each primary wing comprises two said primary thrusters, of which a first primary thruster having a fixed pitch optimized for vertical flight and a second primary thruster having a fixed pitch optimized for horizontal flight.

Preferably the first and the second primary thruster are counter-rotating from each other.

The presence of two rotors per part ensures greater safety as the aircraft can be kept in flight with any rotor failure. Including six or more rotors, of which four primary thrusters and two secondary thrusters, allows to ensure the controllability of the aircraft both in take-off and in transition and in horizontal flight even in the event of failure.

The presence of two primary thrusters per part also makes it possible to have the two primary thrusters with optimized pitch for vertical flight and for horizontal flight, respectively. Advantageously, the primary thruster with optimized pitch for vertical flight is provided with means for positioning the blades parallel to the airflow during horizontal flight, so as to be able to be stopped and minimize the offered resistance to air.

In an embodiment, said primary and secondary thrusters are driven by electric motors. The aircraft can therefore be fully electric, hybrid or hydrogen powered.

In an embodiment, cushioned ground support elements are included placed on the primary wings, which support elements are protruding downwards in said vertical configuration of the primary wings.

Advantageously, the cushioned support elements on the ground are placed at the ends of the primary wings.

Thereby, the aircraft in ground condition rests directly on the primary wings, in particular on the ends thereof, ensuring great constructive simplicity and a wide support base which ensures good stability on the ground.

According to a further embodiment, a front retractable ground support pad is included. Three support points are thereby identified which define a triangle. This improves the stability of the aircraft on the ground and allows parking even on slightly rough terrain. The front retractable fuselage pad and the support on the primary wings confers high constructive simplicity and avoids the presence of pads or fixed carriages which can give greater aerodynamic resistance and therefore significantly worsen flight performance.

According to a further embodiment, the aircraft can be unassembled in separate parts having dimensions such that they can be transported together in a standard sized container.

From the above, it is evident to the person skilled in the art that the aircraft of the present invention, unlike other VTOLs known in the state of the art, has a simple and essential design which ensures excellent aerodynamic finesse and features similar to those of fixed-wing aircraft.

These and other features and advantages of the present invention will become clearer from the following description of some non-limiting exemplary embodiments illustrated in the attached drawings in which:

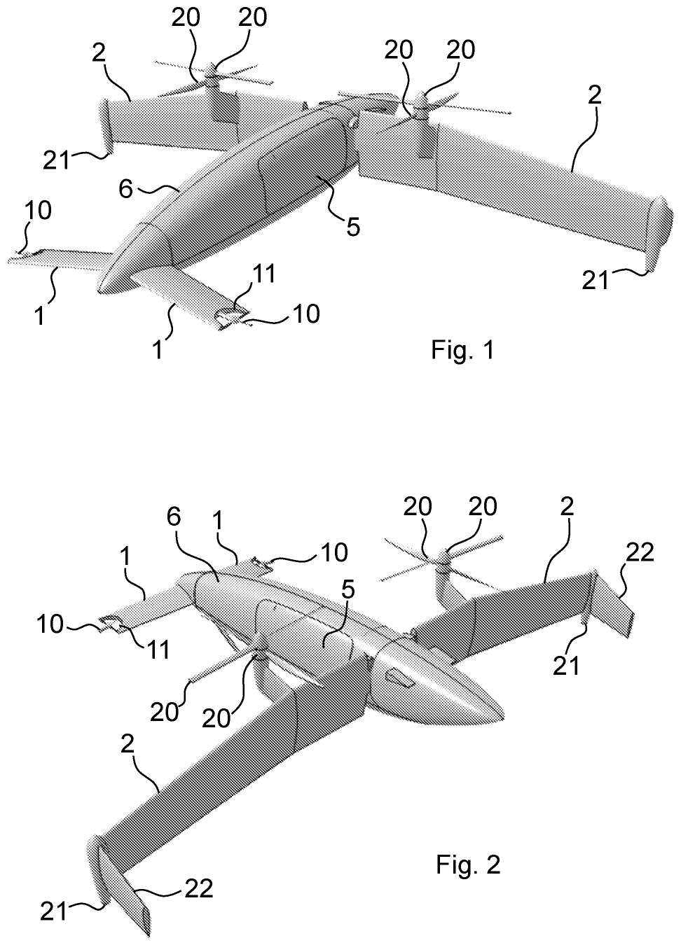

FIGS. 1 and 2 illustrate two views of the aircraft with the primary wings in vertical configuration;

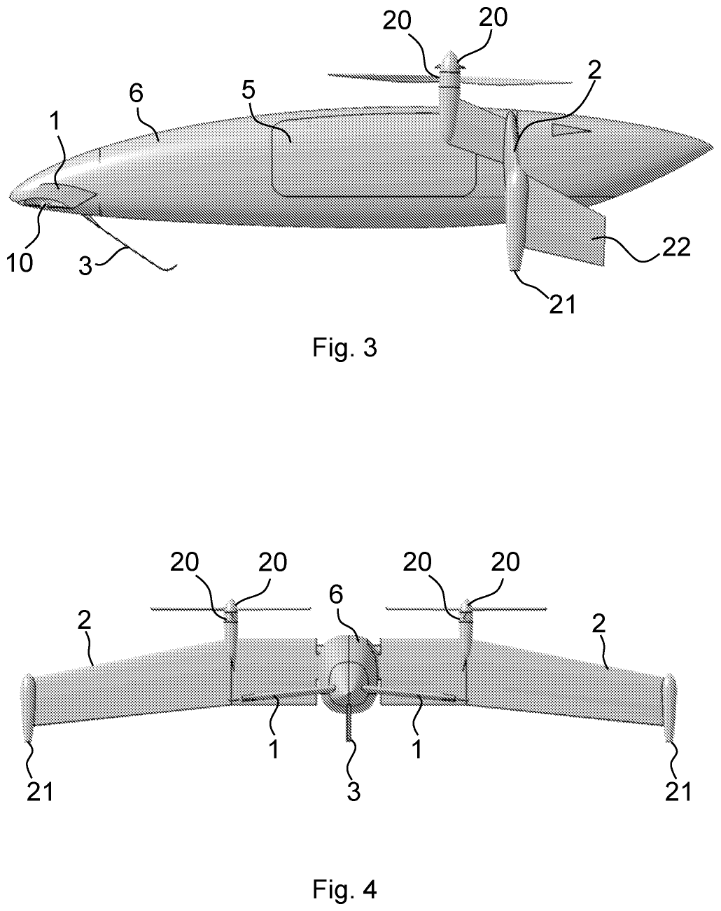

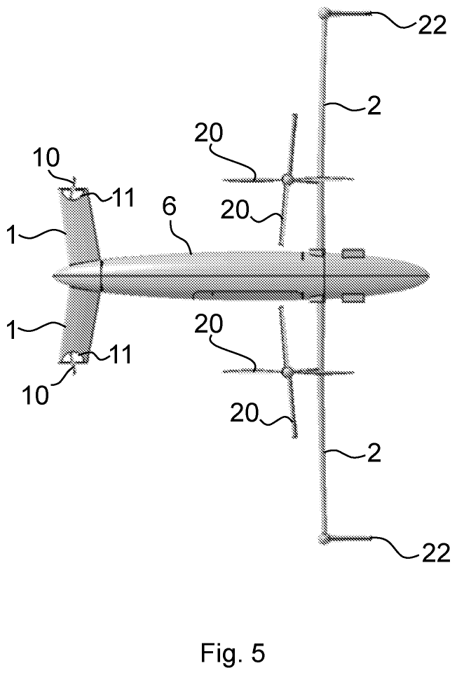

FIGS. 3, 4 and 5 illustrate side, front and top views respectively of the aircraft with the primary wings in vertical configuration;

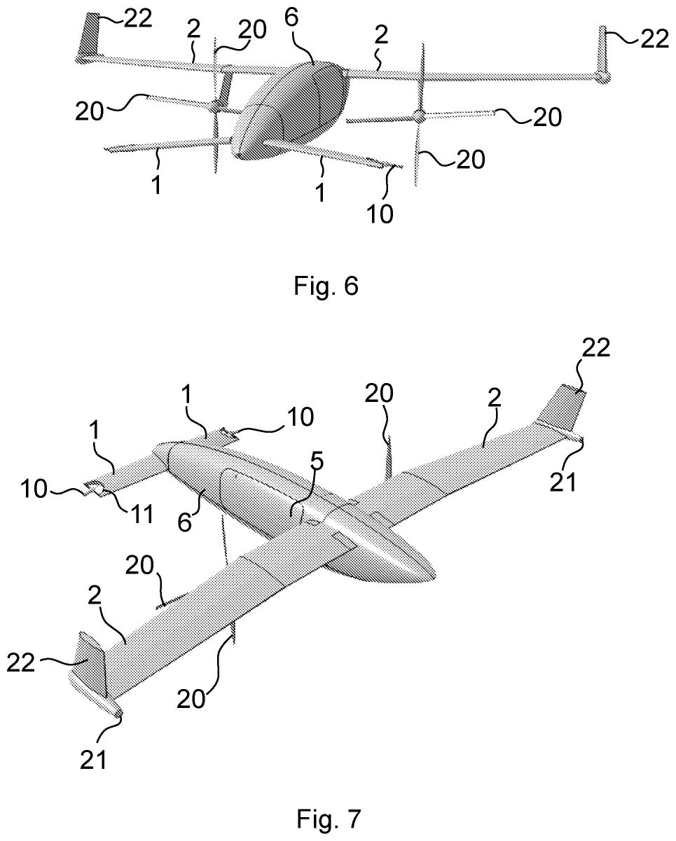

FIGS. 6 and 7 illustrate two views of the aircraft with the primary wings in horizontal configuration;

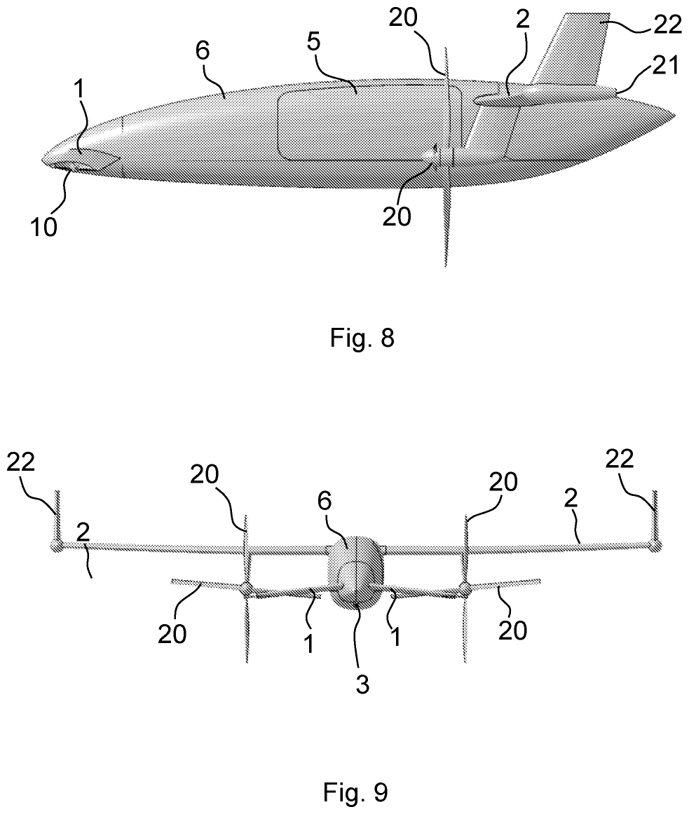

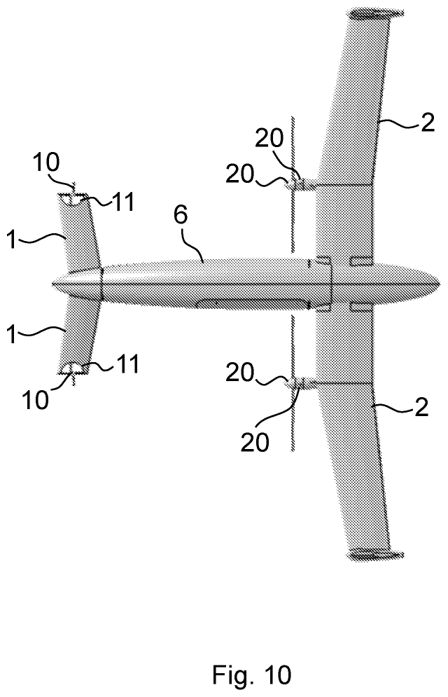

FIGS. 8, 9 and 10 illustrate side, front and top views of the aircraft with the primary wings in horizontal configuration, respectively;

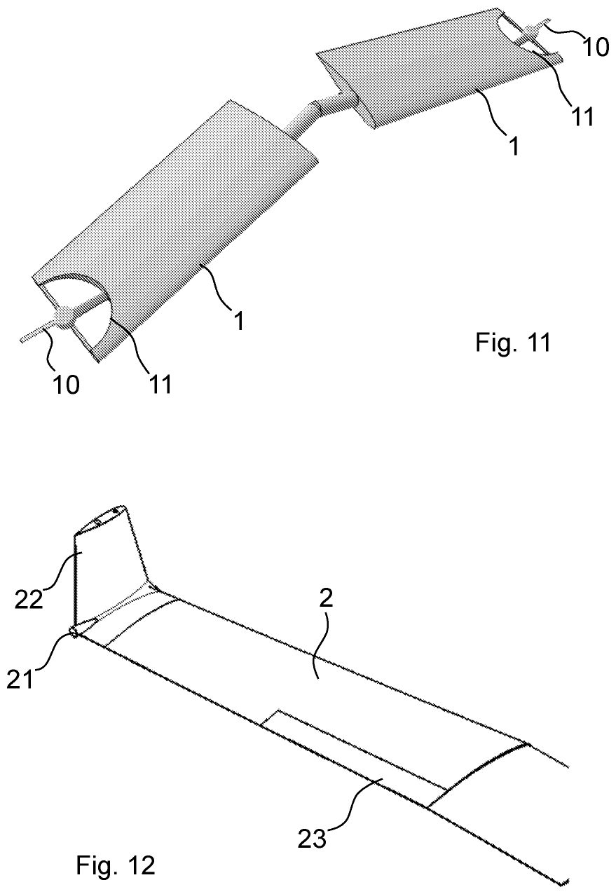

FIG. 11 illustrates a detailed view of the canards;

FIG. 12 illustrates a detailed view of a primary wing;

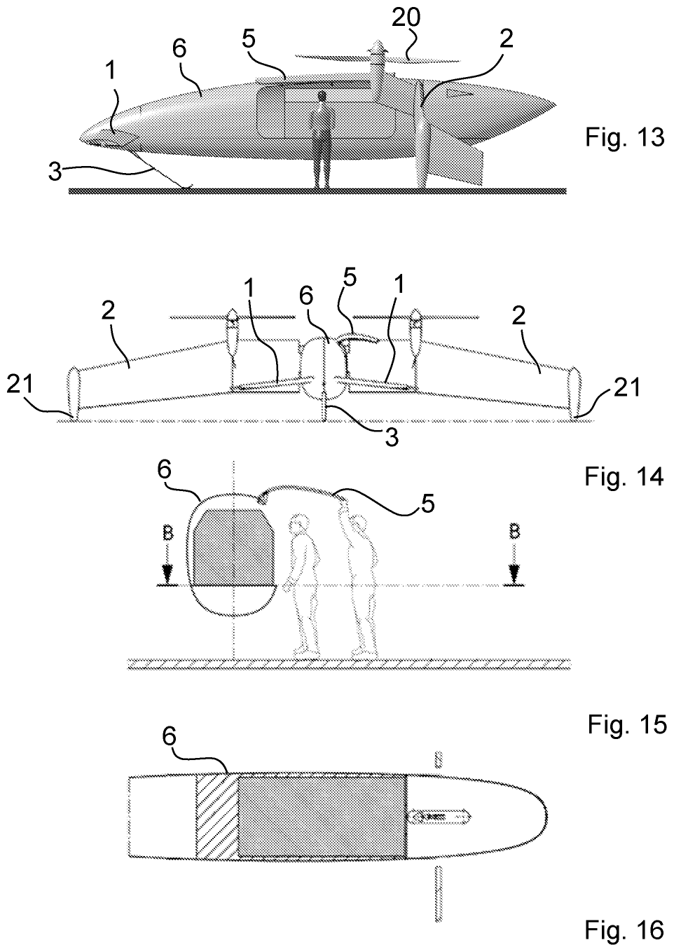

FIGS. 13, 14, 15 and 16 illustrate different overall views of access to the fuselage of the aircraft;

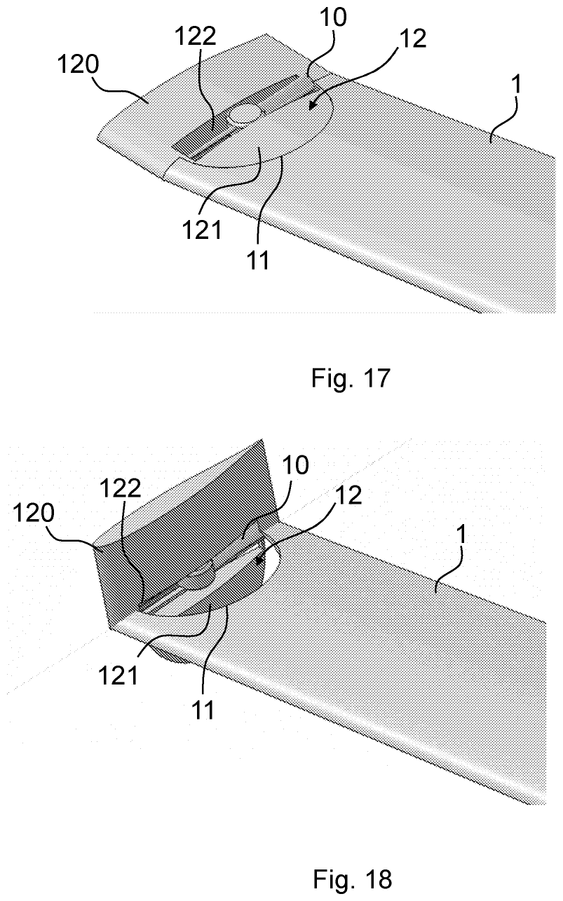

FIGS. 17 and 18 illustrate the end of a canard in different operating conditions;

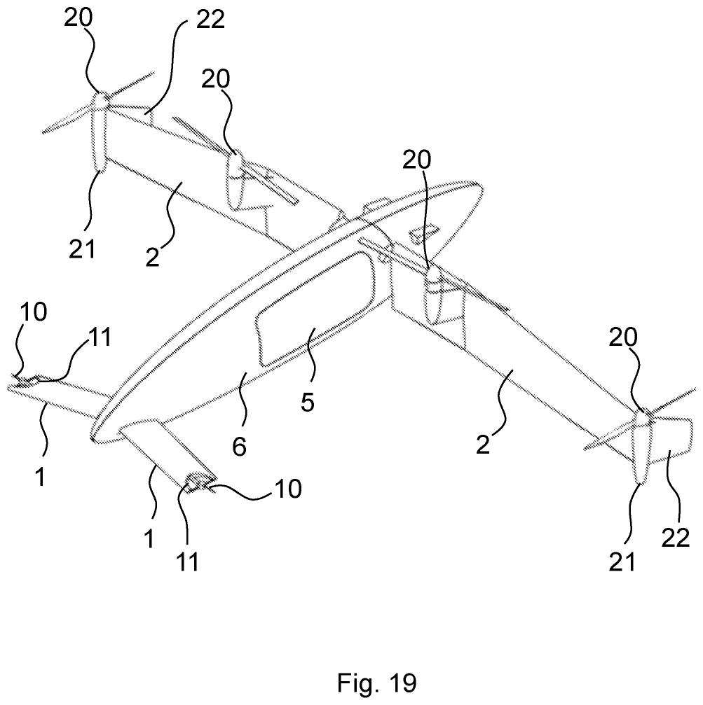

FIG. 19 illustrates an embodiment with non-coaxial paired primary thrusters;

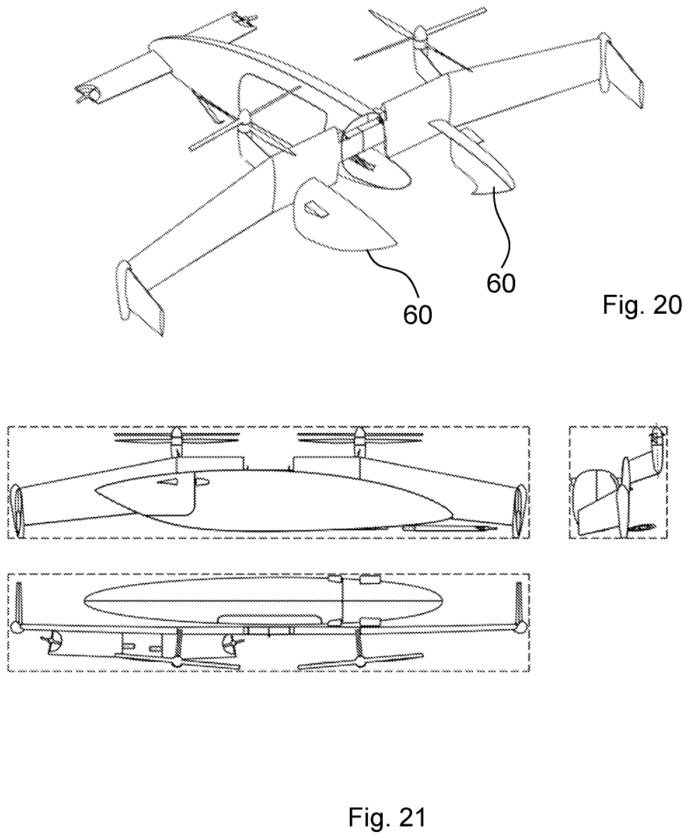

FIGS. 20 and 21 illustrate the unassemblability of the aircraft in parts for container transport.

The aircraft object of the present invention, whose embodiments are illustrated in the figures, is a vertical take-off aircraft characterized by a pair of non-rotating front wings 1, called canards, and a pair of rotating primary wings 2 to which the main thrusters 20 are fixed.

The primary wings 2 are rotatable in a vertical configuration for vertical flight mode, illustrated in FIGS. 1 to 5, and in a horizontal configuration for horizontal flight mode, illustrated in FIGS. 6 to 10.

The primary wings 2, located at the rear, on the ground and at take-off are rotated vertically. In this configuration, the aircraft detaches from the ground vertically supported by the rotors 20 positioned on the primary wings 2 and by those on the canards 1. Subsequently, the primary wings 2 and the primary rotors 20 rotate from vertical to horizontal while the aircraft increases its translation speed in a phase called transition. When the primary wings 2 have reached the horizontal position and sufficient speed, the weight of the aircraft is fully aerodynamically supported by the primary wings 2 and the canards 1 and the secondary front rotors 10 are stopped, while the wings 20 push the aircraft longitudinally as in any fixed-wing aircraft.

In the embodiments of the figures each primary wing 2 is provided with two primary thrusters 20, but it is possible to include only one primary thruster 20 per primary wing 2 or more than two primary thrusters 20.

The canards 1 in vertical flight mode are arranged substantially parallel to a plane perpendicular to the flight direction. Each canard 1 is provided with a secondary thruster 10 oriented for vertical flight mode and at least partially comprised in the profile of the canard 1 itself. The front wing 1 thus includes at the end two secondary rotors 10 coplanar and inside the canard 1 itself.

The canards 1, illustrated in detail in FIG. 11, are provided with terminal housing recesses 11 rotated by the secondary thrusters 10. The recesses 11 are advantageously semicircular, but other shapes can be included.

Each secondary thruster 10 comprises two blades which in horizontal flight mode are stationary and arranged parallel to the longitudinal axis of the aircraft to complete the terminal profile of the corresponding canard 1. Therefore, the front rotors 10 are partially or totally inside the canards 1 and stop, during horizontal flight, in a longitudinal position, as shown in FIGS. 17 and 18.

The secondary thruster 10 is fixed on a bracket placed at the mouth of the recess 11, preferably in a diametral position thereto. Thereby the excursion of the blades is 180° inside the recess 11 and for the further 180° free outside the profile of the canard 1.

Each primary wing 2 preferably comprises two primary thrusters 20 counter-rotating to each other. Such primary thrusters 20 can be coaxial in pairs, as disclosed in European patent application EP3760536A1.

The two counter-rotating primary thrusters of each primary wing 2 can have different propeller pitch from each other so that a first rotor is mainly used for take-off, while the second rotor is mainly used for horizontal flight and has a propeller pitch optimized for this condition.

In the presence of two main rotors 20 per part, the blades of the one used for take-off stop parallel to the airflow, i.e., rotated to minimize their resistance, in horizontal flight mode.

Alternatively or in combination, the primary thrusters 20 can be mounted at different positions, as illustrated for example in FIG. 19. In this case the internal thrusters, closest to the fuselage 6, are preferably those used for vertical flight, while the external ones are those used for horizontal flight. The blades of the internal thrusters, during horizontal flight, are arranged parallel to the air flow or, preferably, they fold along the longitudinal axis of the aircraft.

In the event instead of a single primary thruster 20 per primary wing 2, the propeller pitch can be variable or fixed. In the event of fixed propeller pitch, this will be optimized for horizontal flight.

The canards 1 are fixed or, preferably, orientable only for incidences such that the aircraft can perform manoeuvres during horizontal flight. In order to control stability and arrangement in horizontal and transition flight, the aircraft is therefore provided with control surfaces consisting of:
Canards 1 which are independently rotated, changing the incidence and therefore they generate aerodynamic moments along the roll axis or along the longitudinal axis. This rotation, during the take-off and landing phases, also allows control the yaw.
Flaps 23 in the back of the primary wings 2, visible in FIG. 12; these flaps 23 control both the alignment along the roll axis or along the longitudinal axis, alternatively or in conjunction with the rotation of the canards 1.

Finally, it is possible to include fixed vertical surfaces 22 at the end of the primary wings 2, called winglets, which confer directional stability to the aircraft during horizontal flight.

Preferably, the primary thrusters 20 and secondary thrusters 10 are driven by electric motors.

The aircraft is intended primarily but not exclusively for electric propulsion and has features which allow it to be used with adequate distance and load capacity even with batteries or with hydrogen power supply. Thus, in both of these cases, it is a totally emission-free ecological aircraft.

There are cushioned ground support elements 21 placed at the ends of the primary wings 2. Such support elements 21 are protruding downwards in the vertical configuration of the primary wings 2.

A front retractable pad 3 resting on the ground is included.

Upon landing, the aircraft therefore rests on the front pad 3, included in a central and retractable position in the fuselage 6, and on the two cushioned elements 21 resting on the ground which rearly emerge from the primary wings 2. These cushioned elements 21 form landing gears which can be provided with wheels for movement on the ground.

On the ground, as shown in FIGS. 13 to 16, the position of the canards 1 and the rear primary wings 2 allows easy access to the central fuselage 6 for loading and unloading, for example by opening a door 5, so much so that the primary thrusters 20 are rotated upwards and therefore lie on a horizontal plane in an elevated position with respect to the ground and cannot therefore be hit and/or create obstruction to access.

The aircraft can be unmanned and the fuselage 6 can accommodate a cargo hold and/or cabin for one or more passengers. Alternatively, it is possible to include a cockpit for piloting and passenger transport.

As illustrated in FIGS. 17 and 18, each canard 1 is provided with a closing element 12 of the terminal semicircular recess 11. The closing element 12 is positionable in the recess 11 in horizontal flight mode.

The closing element 12 is hinged to the canard 1 and has a first portion 120 shaped at the wing end and a second portion 121 shaped complementary to the semi-circular recess 11, therefore of full semi-circular shape. The first and second portions 120 and 121 are separated by a through slot 122 for housing the secondary thruster 10.

Thereby, the closing element 12 is movable from a closing condition in which it is positioned in the recess 11 and completes the profile thereof to an opening condition in which it is rotated away from the recess 11.

In the closing condition, the second portion 121 is positioned in the recess 11 while the first portion 120 is positioned so as to follow the canard 1 and form the head end thereof. At the same time, the secondary thruster 10 is positioned with the blades arranged along the longitudinal axis and is housed in the slot 122 included between the two portions 120 and 121, being hidden in the wing and in shadow with respect to the relative movement of the air.

Advantageously, the opening condition includes a positioning of the closing element 12 along the vertical direction or in any case along the vertical flight direction. Thereby, the closing element 12 does not exert any significant resistance to vertical motion. The rotation of the secondary thruster 10 is ensured by the presence of the slot 122 between the two portions 120 and 121 of the closing element 12.

In the embodiment of FIG. 19, the primary thrusters 20 are not included coaxial in pairs. Conversely, a pair of primary thrusters 20 is placed at the respective ends of the two primary wings 2. This positioning is advantageous for aerodynamic turbulence reasons created by the thrusters themselves. Furthermore, the primary thrusters 20 at the ends of the primary wings 2 exploit for their housing the enlargement of the head of the wing 2, necessary to house said cushioned elements 21. Alternatively, the external primary thrusters 20 can be positioned not at the end but in other positions on the primary wings 2.

All the features described above allow the aircraft, in horizontal flight, to have minimum aerodynamic resistance, similar to that of a fixed-wing aircraft.

FIGS. 20 and 21 show the unassemblability of the aircraft in separate parts having dimensions such that they can be transported together in a standard size container, preferably forty feet.

Thereby the aircraft can be disassembled in parts (fuselage 6, primary wings 2, canards 1), which can be shipped inside a container.

By removing two tail panels 60 it is possible to access the junction of the primary wings 1, coupled to the rest of the aircraft by means of removable fixing means, so that they can be disassembled.

1. Vertical take-off aircraft provided with canards and primary wings, which primary wings are provided with two or more primary thrusters, the primary wings being rotatable alternately in a vertical configuration for vertical flight mode and in a horizontal configuration for horizontal flight mode,
characterized in that
the canards in said vertical flight mode are arranged substantially parallel to a plane perpendicular to the flight direction, each canard being provided with a secondary thruster oriented for vertical flight mode and at least partially comprised in the profile of the canard itself.

2. Aircraft according to claim 1, wherein the canards are provided with recesses for housing terminals rotated by the secondary thrusters.

3. Aircraft according to claim 2, wherein each said secondary thruster comprises two blades, which blades in horizontal flight mode are stationary and arranged parallel to the longitudinal axis of the aircraft to complete the end profile of the canard.

4. Aircraft according to claim 2, wherein each canard is provided with a closing element of the terminal recess, which closing element is positionable in the recess in horizontal flight mode.

5. Aircraft according to claim 4, wherein the closing element is hinged to the canard and has a first shaped portion at the end of the canard and a second portion shaped complementary to said recess, which portions are separated by a through slot for housing the secondary thruster.

6. Aircraft according to claim 1, wherein each primary wing comprises two said primary thrusters of which a first primary thruster having a fixed pitch optimized for vertical flight and a second primary thruster having a fixed pitch optimized for horizontal flight.

7. Aircraft according to claim 1, wherein said primary thrusters and secondary thrusters are driven by electric motors.

8. Aircraft according to claim 1, wherein cushioned ground support elements are provided on the primary wings, which support elements are protruding downwards in said vertical configuration of the primary wings.

9. Aircraft according to claim 1, wherein a front retractable pad resting on the ground is included.

10. Aircraft according to claim 1, unassemblable in separate parts having dimensions such that they can be transported together in a container of standard size.
